(19) United States
(12) Patent Application Publication
(10) Pub. No.: US 2005/0012287 A1
(43) Pub. Date: Jan. 20, 2005

(54) Handle arrangement for a pushchair

(76) Inventor: Simon Antonio Goldenberg, Barcelona (ES)

Correspondence Address: SIMON A. GOLDENBERG, 42 FIELDS PARK ROAD, NEWPORT, NP20 5BB, GB

(21) Appl. No.: 10/891,058

(22) Filed: Jul. 15, 2004

(30) Foreign Application Priority Data
Jul. 17, 2003 (GB) GB0316688.1

(51) Int. Cl. B62B 9/00

(52) U.S. Cl. 280/47.38

(57) ABSTRACT

A handle arrangement for a pushchair that has first (112) and second (110) substantially upwardly extending members that are connectable to a handle arrangement at their upper portion. The handle arrangement comprises a first handle member (101) and a second handle member (100), the first handle member (101) is connectable to member (112) and the second handle member (100) is connectable to member (110), and a portion (104) of one of the handle members (101) extends through the axis of symmetry of the pushchair to permit, when the portion (104) is fully gripped, a momendess single handed pushing of the pushchair, the arrangement being such that under a normal operating condition a gap (108) is allowed between the ends of said first and second handles for hanging there through a loop such as that of a bag. Second handle member (100) can also have a portion extending through the plane of symmetry of the pushchair (See FIG. 7C) and the handles can themselves be angularly adjustable via joints (106, 206).

### BACKGROUND OF THE INVENTION

1. Description of Prior Art

Handle arrangements for pushchairs are generally of two types: a first type having twin handles that is normally used in umbrella type folding pushchairs where the structure is collapsed generally in three dimensions i.e. length, height and width, and a second type having a single full width handle where the structure is collapsed in generally two dimensions, i.e. length and height. However there have been cases where the two handle arrangements have been used on both types of structures. Both systems have their advantages and drawbacks. The main advantage of the twin handle system is that it permits easy and simple collapse mechanism for a structure that needs collapsing in the width, like most umbrella type collapsing structures. Another advantage is that the handles can be used as hooks for carrying bags, which is very important for parents that normally go shopping with their children. Pushchairs do normally come with carrying baskets generally located below the seats, but these likely to be used in great measure for carrying toys and bags with all the kit for feeding and changing the child. In a properly designed pushchair, the handles can be used for transporting many shopping bags resulting for example from a visit to the supermarket and the twin handle system is ideal for holding bags with all types and sizes of handles or straps. The main disadvantage however is that the twin handle system is not well suited for being pushed with only one hand. This problem is important as many babies and toddlers do not like to sit too much time in the pushchair and they have to be carried in arms for certain periods of time until they are happy to sit in the pushchair again. This can also be a full time problem in the case of parents or carets having to deal with more than one child. Other occasions are bf course when one hand is busy carrying anything else like, for example, bags or umbrellas. While the problem of pushing a twin handle pushchair with one hand may be minor when the pushchair is empty or very light and the wheels are locked in straight direction, it becomes a hassle to control when it is loaded with a child and bags and the front wheels are unlocked, i.e. freely rotatable in the horizontal plane in the same way as casters. The difficulty is due to the moment produced by exerting the forward pushing force on one point in a direction that is offset to vertical longitudinal plane containing the centre of gravity of the pushchair, and this moment tends to make the pushchair turn. This can only be counteracted by a counteracting moment on the handle that would be exerted by the wrist of the user or partially by locking of the wheels in straight position. None of these solutions give satisfactory results: when the pushchair is loaded the stress on the wrists to keep the pushchair going in straight direction becomes very difficult to sustain and the solution of locking the wheels does not prevent the pushchair from slowing bearing to one side and involves loosing the comfort of the freely rotating caster type wheels. The main advantage of the single handle is that is solves the above mentioned problem of the twin handle system because it allows for pushing of the pushchair with one hand effortlessly as the hand can be located generally on a portion near the centre of the handle. In this position the hand of the user exerts a forward pushing force that is aligned with the vertical longitudinal plane containing the centre of gravity of the pushchair and therefore no horizontal moment is produced that would encourage turning the pushchair. The main disadvantage is that bags cannot be hung to this type of handle arrangement unless the straps are long enough as to encompass the full width of the handle, i.e. fitting around both upwardly extending members. Generally most types of shopping bags will not have a handle large enough to fit around the full width and the bags that are able to be hooked will be limited to the types having substantially long straps.

The last disadvantage is that this handle is not suitable for structures that collapse in all three dimensions.

STATEMENT OF INVENTION—SUMMARY

According to the present invention there is provided a handle arrangement for a pushchair as described in claims 1 to 38.

Definitions

For the purposes of this disclosure the term “fully gripping” when referred to a handle or handle portion, is when all the palm and the fingers of a hand of the user are substantially in contact and wrapped around the handle or handle portion and the hand is substantially centered on the length of the handle or handle portion, i.e. clear of the end boundaries of the handle or handle portion, the end boundaries being for example a free end, an articulation, an end connecting point or the curved section dividing two handle portions. Therefore, when the palm of the user is in contact with a free end of a handle, it will not be considered as “fully gripping” the handle. For the purposes of this disclosure the term “momentless pushing” refers to the application of a single and discrete pure forward-motion producing force that does not have any force components other than within the vertical longitudinal plane of the pushchair that passes through the centre of gravity of the pushchair, and that does not have any bending or flexing moment components at the point of application of the said force in any plane other than within said vertical longitudinal plane, i.e. so that the said force does not encourage the pushchair to turn or does not compensate any bias to turn that the pushchair might have due to involuntary factors such as lack of wheel alignment, surface inclination, etc. For the purposes of this disclosure the term “operating condition” is a condition where the handle arrangement is connected to both of the upwardly extending members, and the pushchair is capable of being pushed and manoeuvred normally via the handle arrangement. For the purposes of this disclosure the term “connection end” refers to a transition point that between a handle part or a portion of structure used as a handle and a supporting part or a portion of a structure used as a support for that handle. The handle arrangement may be a welded, glued, or mechanically connected to the upwardly extending members or may be a seamless extension of the upwardly extending members.

Operation and features

Preferably, the handle arrangement of the invention is configured for pushing with both hands as well as single handedly, and has one handle extending sufficiently as to allow one hand gripping a first lateral handle portion and another hand gripping a second handle portion within the same handle, the second handle portion positioned centrally with respect to the pushchair. Preferably, the handle arrangement may have an optional operating condition where the handles form a substantially continuous structure that links both upwardly extending members, the handle arrangement having another operating condition where the structure that links both upwardly extending members is divided by a gap created along or at one end of the handle arrangement. In this case, both handles can be releasably linked by linking means, which are single handedly operated by the user. Preferably, the handle arrangement may also have one handle extending sufficiently as to allow on hand gripping a first lateral handle portion and another hand gripping a second handle portion within the same handle, the second handle portion positioned centrally with respect to the pushchair.

Specific embodiments of the present invention will now be described by way of example with reference to the accompanying drawings in which:—

### DRAWING FIGURES

FIG. 1A shows pushchair with a continuous single handle (Prior Art).

FIG. 1B shows an umbrella type folding pushchair with independent twin handles (Prior Art).

FIG. 1C shows a basic embodiment of the invention.

FIGS. 2A and 2B shows a hinge arrangement on one of the handles.

FIGS. 2C and 2D show a link arrangement on one of the handles.

FIG. 3A shows a sleeve type coupling for bridging a gap between the handles.

FIGS. 3B and 3C show a close up detail of a type of sleeve as the one used in FIG. 3A.

FIGS. 4A and 4B show a close up details of an internal axial type coupling for bridging a gap between the handles.

FIGS. 4C and 4D show a pivoting latch coupling for bridging a gap between the handles.

FIG. 4E show a pivoting handle that works as a latch coupling.

FIG. 5A shows a brake lever on one of the handle portions.

FIG. 5B shows a twist-grip type brake handle on one of the handle portions.

FIG. 6 shows a hinged handle portion for actioning a cable-operated mechanism.

FIGS. 7A, 7B, 7C & 7D show an arrangement with both handles incorporating a centrally extending portion in different operating conditions.

FIGS. 8A and 8B show a plan view of the handle arrangements of FIGS. 7A-D when the centrally extending portions are horizontally seated or secured and two different possibilities of securing the free ends of both handles.

FIG. 9A shows an elevation of an alternative embodiment of the handle arrangement shown in FIGS. 7A-D, where opposing centrally extending portions are relatively located one on top of the other instead of side to side.

FIG. 9B shows a plan view of the embodiment of FIG. 9A.

FIG. 10 shows an arrangement where the first and second upwardly supporting members are hinged so that the tilt angle of the handle arrangement is adjustable.

FIG. 11 shows the handle arrangement of FIG. 10 incorporating a torsion bar.

FIG. 12 shows the handle arrangement of FIG. 10 incorporating a collapsible torsion bar.

FIG. 13 shows an alternative embodiment with the gap at or near the end of the handle arrangement.

FIG. 14 shows a further alternative embodiment, where the central extending handle portion is part of the latching mechanism.

### DESCRIPTION

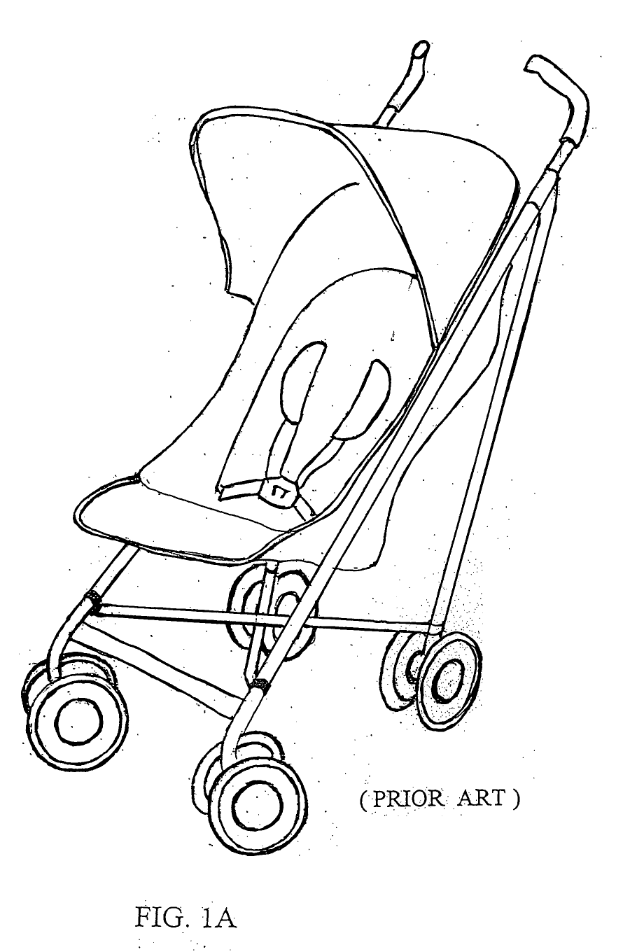

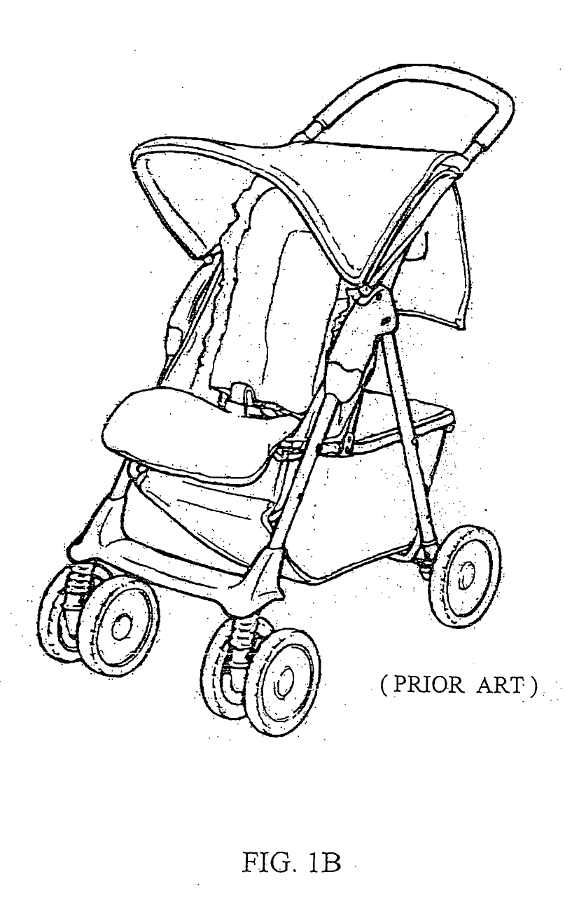

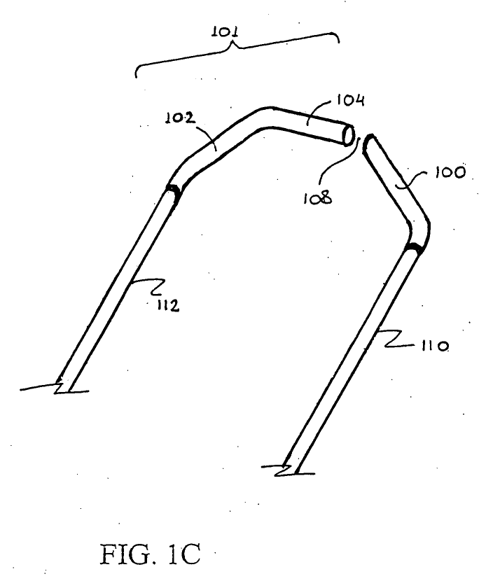

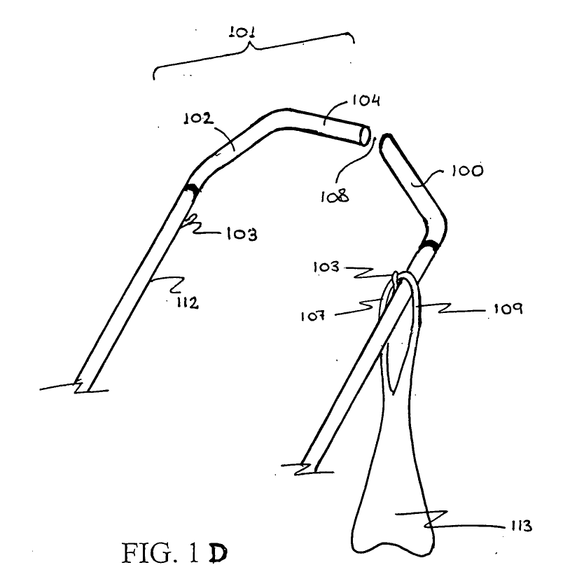

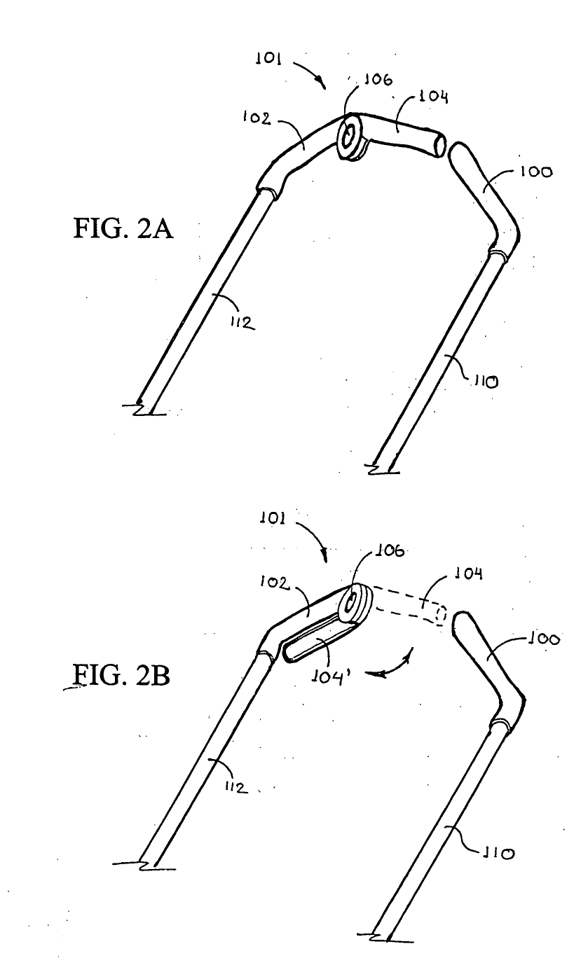

FIGS. 1-6—Preferred Embodiment FIG. 1C shows two upwardly extending members 110 and 112, typically two spaced apart parallel tubular sections common in most types of handlebar systems for pushing strollers and pushchairs. These members terminate in the handlebar arrangement object of the invention, which in its most basic version, consists of a handle of known type 100 and an opposing handle 101 having a portion 102 which is generally similar and symmetrical to handle 100, but which may also be arranged to be different or asymmetrical to 100 taking account of different design or ergonomic criteria, and a handle portion 104 that extends through the plane of the longitudinal axis of the pushchair or pram, so that when a forwardly impulsing force is applied on the grip of this central portion 104, the pushchair is impulsed in a way that produces no horizontal moment respect to its centre of gravity, that is to say, that when a single momendess force is applied by for example one hand of a user on the central portion 104, the pushchair will move in flat even terrain in substantially straight direction without any force exerted on the pushchair that encourages it to turn sideways. In the preferred embodiment handle 100 and handle portion 102 are inclined respect to the upwardly extending members 110 and 112, most preferably inclined inwardly and/or upwardly towards the centre of the pushchair. Portion 104 extends preferably in horizontal direction from the end of portion 102 and towards the free end of handle 100 as can be seen in FIG. 1C. Preferably a gap 108 suitable for permitting the passage of the straps of a bag or a looped member will be left between the free end of handle 100 and the free end of portion 104 or handle 101. FIG. 1D. shows the gap 108, permitting the passage of the straps 109 of a bag 113, left between the free end of handle 100 and the free end of portion 104 or handle 101. It should be noted for example that when the straps 109 or a looped portion of a bag or container 113 are passed through the gap 108 and around a handle portion 100 and then downwardly around an upwardly extending member 10 up to hook 103, there will be only one upwardly extending member within the loop or strap 109, in this case member 110, and the other upwardly extending member, in this case 112, will be outside of the loop or strap 109, and that there will be a portion 107 of the loop or strap 109 lying between the two upwardly extending members. As the handles remain separate in this first basic embodiment, the upwardly extending members can collapse in the direction of the width of the pushchair when it is folded in collapsed mode. Because the handle 101 extends transversely substantially more than handle 100 and it can cause undesired protrusions in the collapsed structure of a pushchair, it could be desirable to provide it with a hinged that is adjustable in position. This hinge is shown in FIG. 2A as hinge 106. This hinge is preferably placed between portions 102 and 104 of handle 101, but could also be placed in other locations such as between the upper portion of the upwardly extending member 112 and handle portion 102. This hinge is in place basically to allow the collapsing of the handle 101 so that it does not cause unwanted protrusions or interference when the pushchair is collapsed. FIG. 2B shows that portion 104 can be rotated around the hinge 106 to a position 104′where the free end of 104 is moved towards portion 102 of handle 101, so as to reduce the transversal dimensions of the handle. The hinge can also be used to rotate the portion 104 in operating condition from the substantially horizontal position shown in FIG. 2A to a position that is still centrally located respect to the longitudinal axis of the pushchair, but tilted respect of the horizontal to accommodate the choice and comfort of users who prefer a tilted central grip. The hinge 106 can be a hinge allowing rotation in a two dimensional plane, but can also be a universal hinge allowing rotation in all three dimensions, both types having arrangements for releasing and tightening or locking the movement. They could also be of the type that is adjustable in unlimited positions or the type that allow movement in certain predetermined positions, like for example the dented or ratchet types. Alternatively instead of a hinge, FIGS. 2C and 2D show a handle portion 104 that could be collapsed by releasably disconnecting it from portion 102 via a releasable connection mechanism 96A, 96B of known type, such as for example a “snap-fit” male-female mechanism, with both portions remaining linked by a linking member such as a chain, tape, cable or rope 98. The releasable connection could be materialised in the form of plugging or screwing one portion end into the other, preferably with a locking or latching feature to prevent unwanted or accidental disconnection. To increase the rigidity of the handle arrangement the two free ends of handle 100 and handle portion 104 can be releasably latched or bridged or secured together by different types of mechanisms.

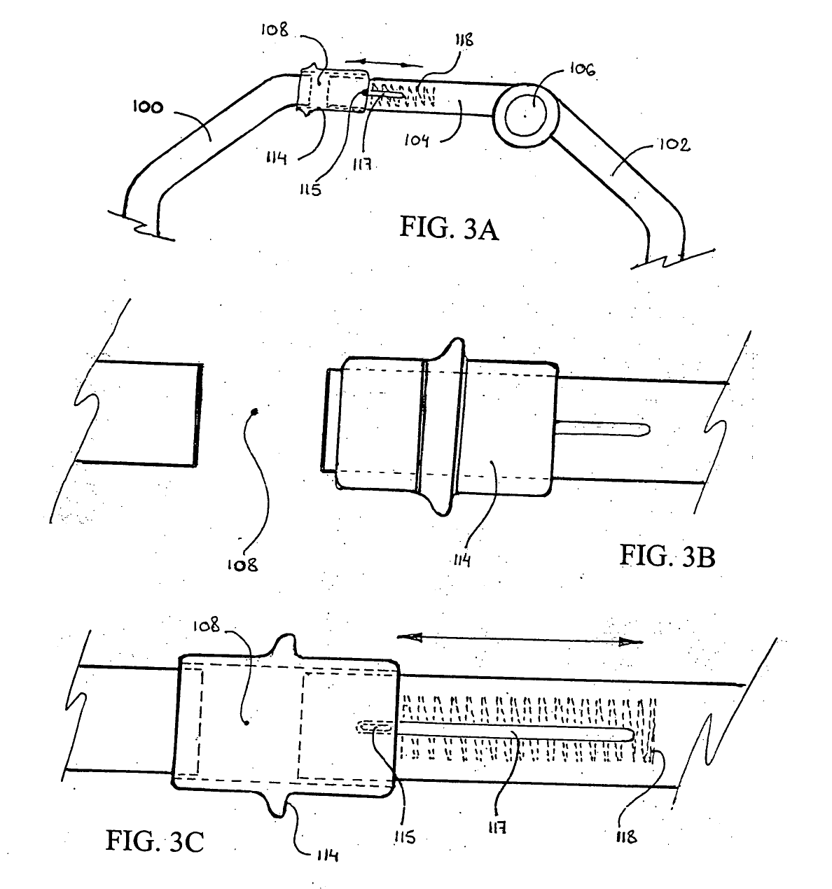

FIGS. 3A, 3B and 3C show a sleeve type mechanism that resides in one of the handles and can be moved across to reach and latch or secure the free end of opposite handle. The sleeve 114 can move axially from one handle towards and over the opposite handle. This axial movement can be attained by a sliding system guided via slot 117 and protrusion 115 and preferably assisted by a resilient element such as a spring 118 so that the sleeve is biased towards the free end of the opposite handle. The sleeve 114 does not necessarily have to be biased by a spring and it could be made to advance in axial direction towards the free end of the opposite handle by a matching thread mechanism, whereby rotating the sleeve 114 around its main axis produces its motion in axial direction.

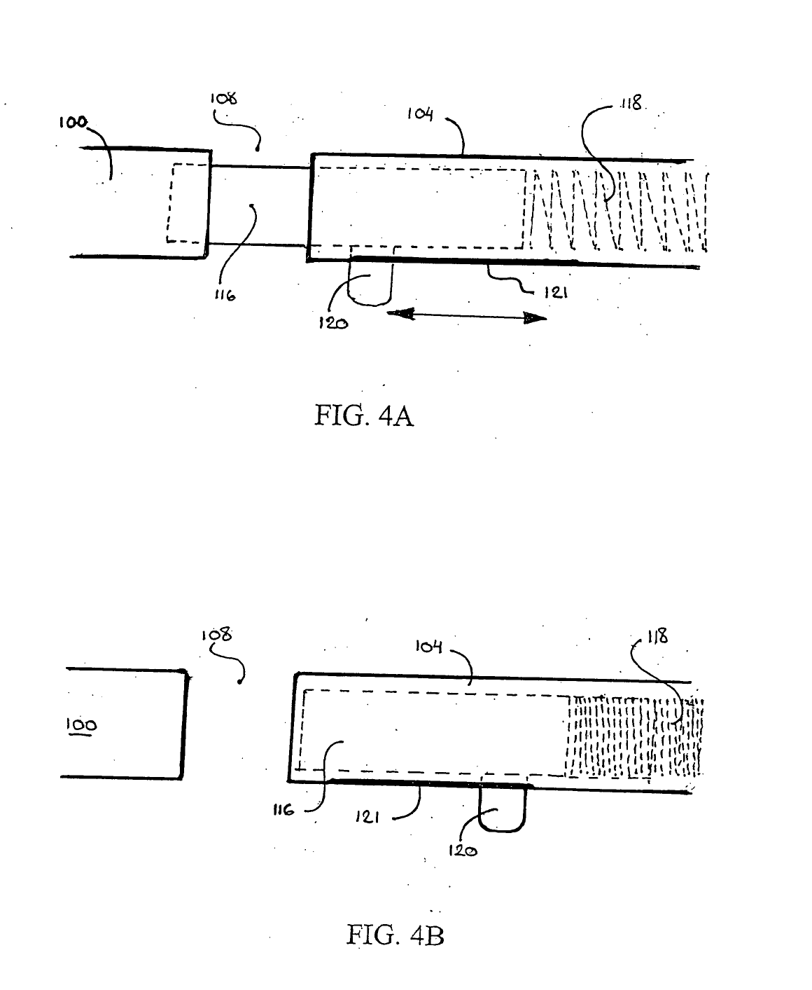

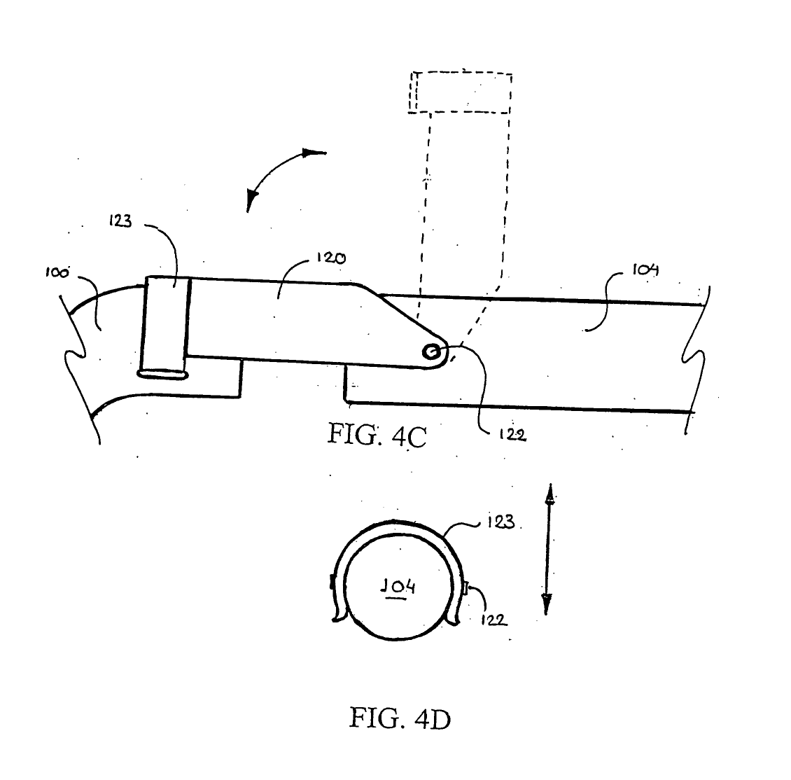

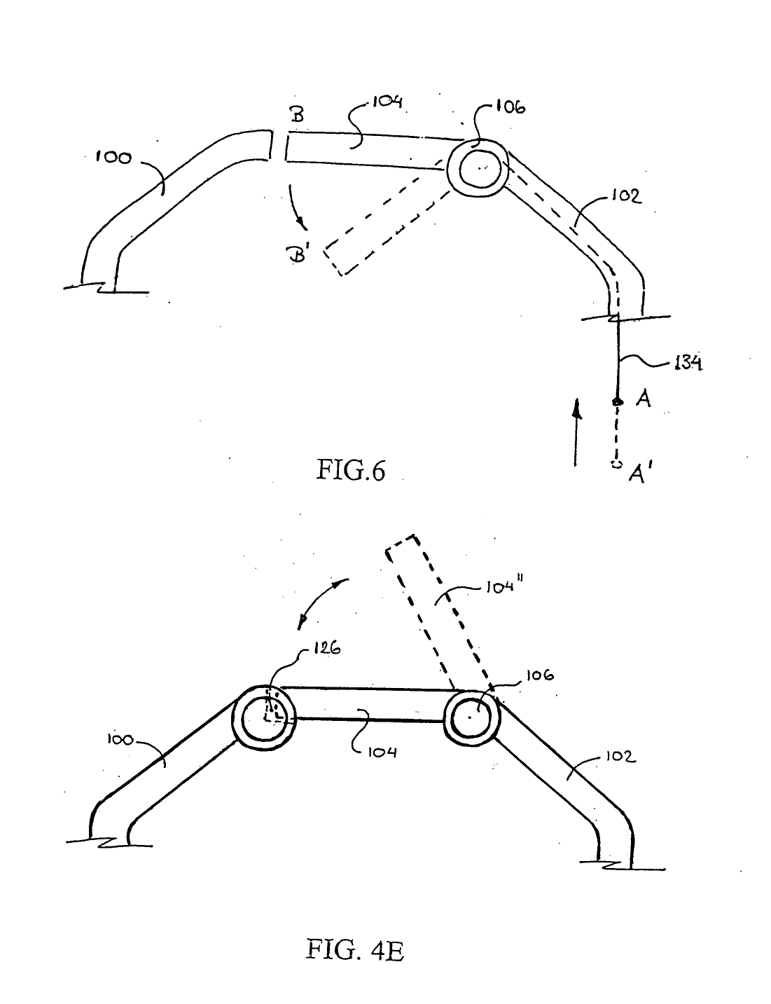

FIGS. 4A and 4B show a securing mechanism similar to the sleeve shown in FIG. 3A to 3C, but where the securing element is a pin or bolt type element 116 housed substantially within the radial boundaries of the handles. Similarly to the sleeve system, the pin or bolt type element can be made to slide via a knob 118 protruding through the side surface of the handle generally via a longitudinal slit 121 and preferably assisted by a resilient element such as a spring 118 so that the element is biased towards the free end of the opposite handle. The bolt or pin element 116 can also be arranged to be driven on its axial direction via a threaded mechanism, such as an rotating nut or ring rotating at a stationary location and driving a threaded but non-rotating pin or bolt 116.

FIGS. 4C and 4D show the use of a latch 120, which is hinged on one of the free ends of a handle 104 and can latch, preferably via a releasably attachable snap fit at end 123 to the free end of the opposite handle 100. The hinge has a rotation axis 122 that is perpendicular to the longitudinal axis of the handle 104. Although the securing systems are shown as resident on the free end of central handle portion 104 in order to secure the opposing free end 100, it is clear that any of the systems shown in FIGS. 3A, 3B, or 3C can alternatively be resident on the free end of the handle 100 with very little modification.

FIG. 4E shows an alternative way of securing the free end of the opposing handles in order to increase the rigidity of the arrangement. In this case is provided a catch element 105 having a portion 126 where the handle portion 104 can be received or seated. For aesthetic purposes, hinge 106 and catch element 105 could be made to share an exterior appearance that has common design elements, although their function would be different. The seat 126 would preferably have a shape so as to complement the shape of the free end section of handle portion 104 and the seat could be for example “U”, “J”, “I” or “L” shaped. The “U” section could be slightly closed at the top end in order to provide a “snap fit” type releasable attachment. Other shapes could secure the free end of handle portion 104 with the aid of latching or locking mechanisms so as to prevent the rotation of handle portion 104 around hinge 106, and therefore its disengagement from seat 126. When using this system, the gap needed between the two free ends of the handle 100 and the handle portion 104, for passing for example the straps of a bag, is produced by unlatching or unlocking the handle portion 104 from its seat 124, and positioning handle portion 104 in the position indicated by 104″. Of course the linking systems described in FIGS. 2C to 4E may all incorporate a support or lock that either locks them in open or in closed position.

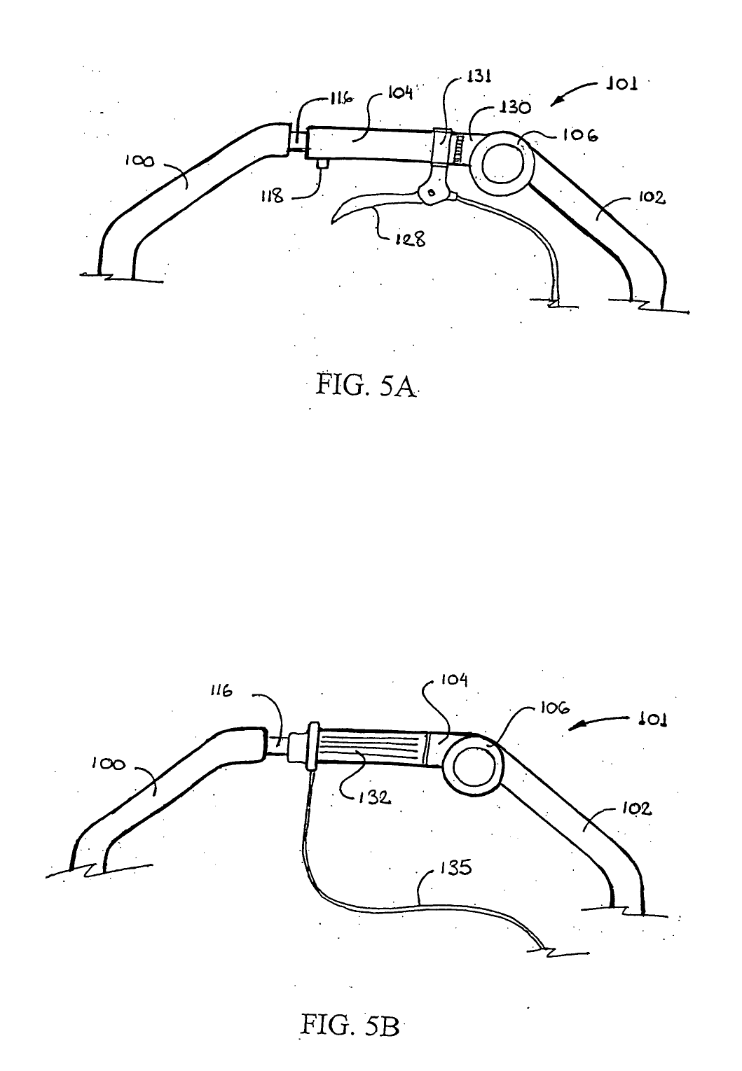

FIG. 5A shows the optional incorporation of a braking lever 128. The lever is shown located on handle portion 104, but could also be located on portions 102 or handle 100. Any of the systems described for securing the two free ends of the handles together could also be used in conjunction with the brake lever and shown in the figure is the securing mechanism shown in FIGS. 4A and 4B. Also optional but shown in this case is the hinge 106 for handle 101. When the hinge 106 is used, a fixed position of the brake lever on handle portion 104 might prove to be cumbersome when trying to fold the handle portion 104 around hinge 106, as either the brake lever structure itself or the cable could provide resistance to a complete folding of handle portion 104. For these cases handle portion 104 could have a portion that is axially rotatable respect to part 130 that is fixed to one portion of the hinge 106. This rotation could be a free rotation or a rotation that could be releasably locked. The axially rotating portion could be a small ring where the brake lever is attached or it could be the remaining length to the free end from the location where the brake is attached. The preferred securing systems described in FIGS. 4A and 4B would be those described as the axially sliding type, as they are not affected by axial rotation. Nevertheless the threaded securing mechanisms could still be used as described, provided the rotation or the axially rotating portion of the handle can be releasably locked.

FIG. 5B shows the handle arrangement equipped with a “twist grip” type brake lever 132 having a cable 134 used on portion 104 of a handle 101 where similar considerations to the standard brake lever apply. The brake lever 132 can also be located, if preferred on handle 100 or on handle portion 102.

FIG. 6 shows the handle arrangement with handle portion 104 that actuates on a cable 134 when it is rotated around hinge 106, in order to provide a pull cable system that can modify the position of the cable from “A” to “A′” or/and vice versa, for controlling other mechanisms in pushchair. These other mechanisms can be for example the unlocking or unlatching of the folding mechanism, unlocking or unlatching the set inclination of the seat of the pushchair or the set inclination of the whole or portion of the upwardly extending members that support the handle arrangement. The cable 134 could also actuate a brake mechanism, a turn mechanism and other mechanisms that can be controlled with a translational movement. This pull cable feature can be used in combination with all the different versions of the handle arrangement shown in this document.

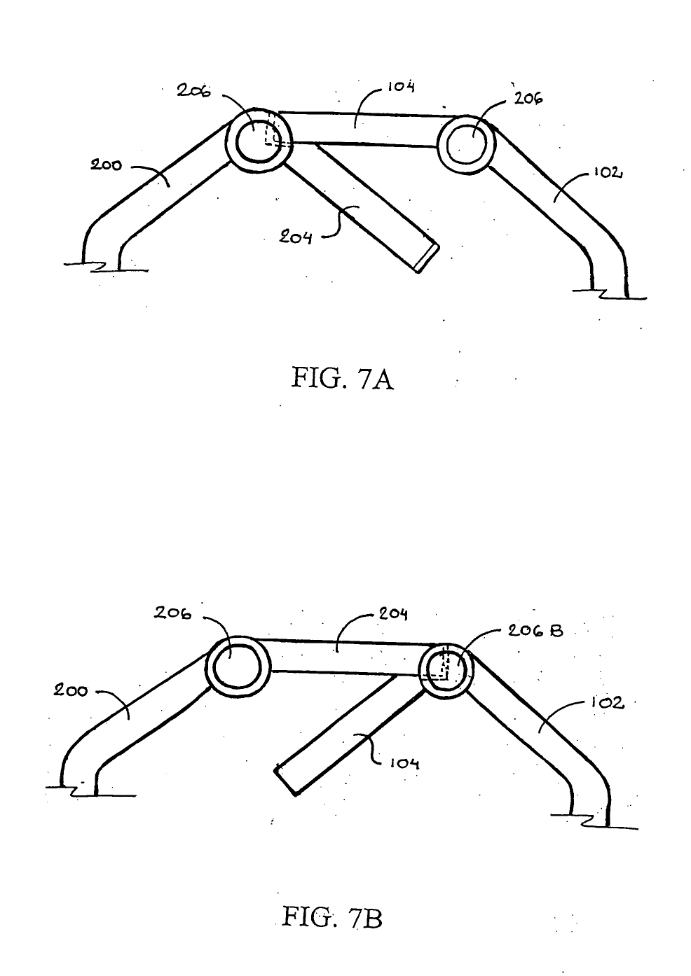

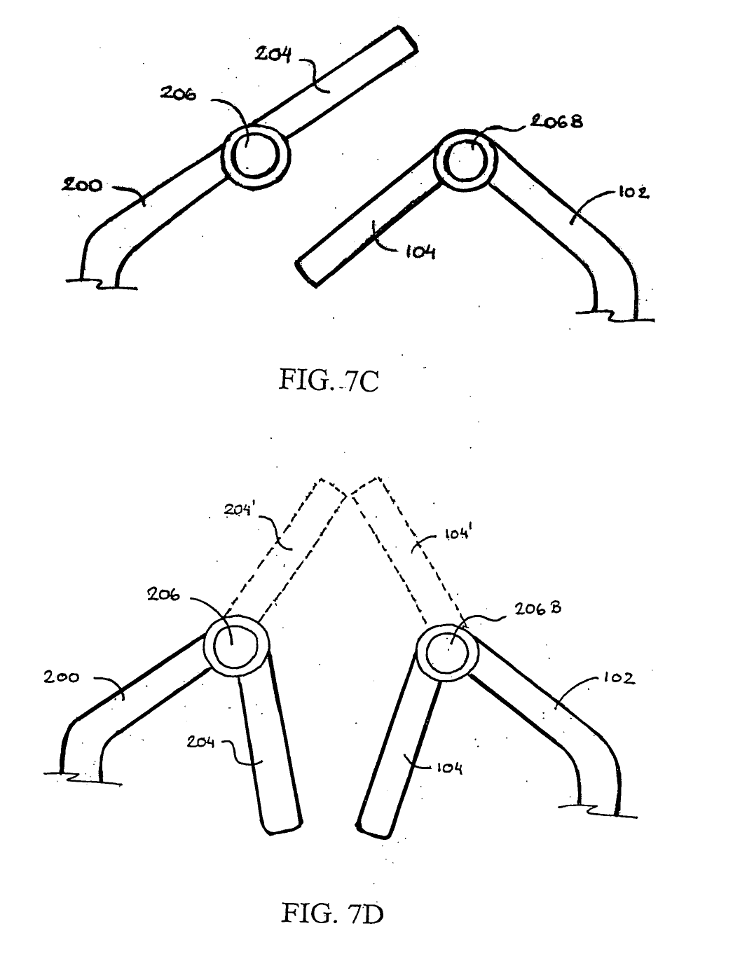

FIGS. 7-9—Alternative Embodiments

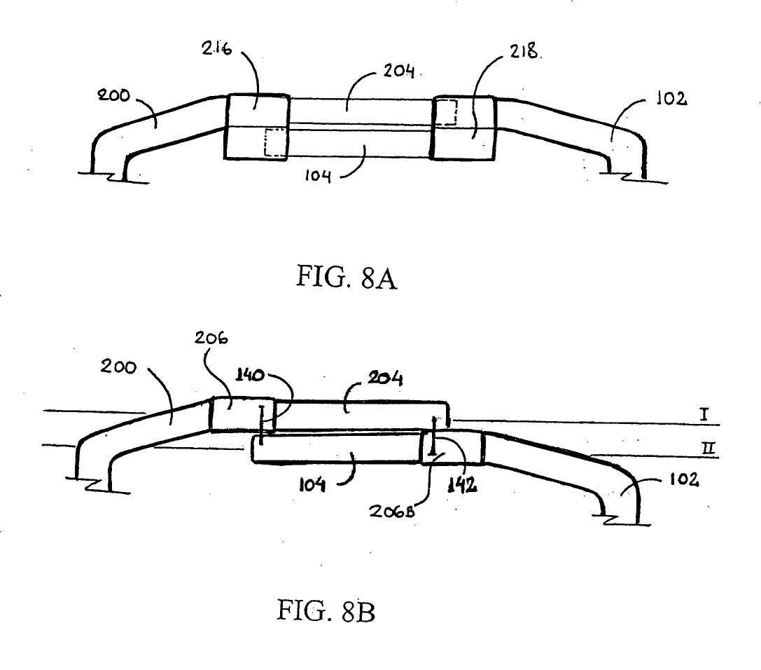

FIG. 7A to 7D show a handle arrangement that has two handle portions 104 and 204 that extend near or through the vertical plane passing through the centre of gravity of the pushchair, in a similar way as portion 104 did before. Handle 100 is now divided into two portions 200 and 204 that are joined together via a hinge 206 having the hinge characteristics and features that were described for hinge 106. Hinge 206 can be preferably constructed so as to also provide a seat having the features described for seat 126, in order to receive the free end of handle portion 104. Hinge 206B has the features that where described for hinge 106 and can also preferably be constructed so as to provide a seat having the features of seat 126. Similarly hinge 106 may be replaced now with a hinge 206B having similar functional characteristics as hinge 206. With this construction, the hinges 206 and 206B may need to be slightly offset respect to one another. This offsetting is introduced to accommodate the members 104 and 204 when they are positioned parallel to one another as shown in FIGS. 8A and 8B, which shows a top view of the arrangement. If the hinges 206 and 206B have only a width similar to the dimension of the diameter of the handle portions 104 or 204, as in FIG. 8B, the free ends of these portions can be optionally secured to the opposing hinges by means of latches, and sliding and/or rotating pins or bolts 140 and 142. However, in a further embodiment, the handles can be provided with hinge and catch combinations 216 and 218, which are basically the combination of a hinge of the type 106 with a catch of the type 124 having a seat 126 (see FIG. 4E), arranged as one unit, preferably in side to side fashion.

FIG. 8B shows an arrangement where handle portion 204 moves in a plane generally parallel to handle portion 104, in the case that the hinge is a bi-dimensional hinge, so that when they are both in horizontal position, one will be located in side to side fashion with the other, and in the example, portion 204 is shown located at the rear of portion 104. In this horizontal position, the handle portion 204, the hinge corresponding to portion 204 and the catch that is linked with the hinge of portion 104 and that received the free end of portion 204 will all be in the same plane I. Similarly the handle portion 104, the hinge corresponding to portion 104 and the catch that is linked with the hinge of portion 204 and that receives the free end of portion 104, will all be in the same plane 11, with planes I and II being parallel to each other. In FIG. 8A, the hinge catch combinations 216, 218 can be achieved for example with a structure where a hinge of the type 106 is connected in side by side fashion to a catch of the type 105 as can be seen in FIG. 8B.

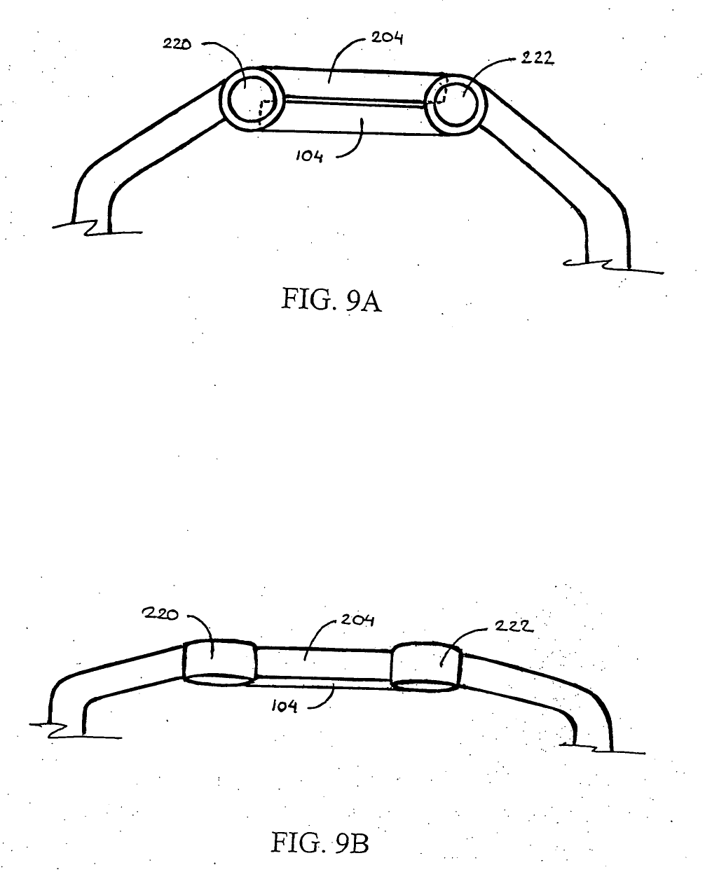

FIGS. 9A and 9B shows an arrangement where handle portion 204 moves in the same plane as handle portion 104, in the case where the hinge is a bi-dimensional hinge, so that when they are both in horizontal position, one will be located above the other. In the example of the figure, portion 204 is shown located above portion 104. In this horizontal position, the handle portions 204 and 104, and the catches with the seats that receive the free ends of the handle portions, will all be in the same plane. The hinge catch combinations 220, 222 can be achieved, for example, with a structure similar to two wheels, linked by a common axis, which is the hinge, to which one portions of the handle that is rigidly linked with. The other portion of the hinged handle is fixed between the two wheels that rotate relative to the hinge. The space between the two wheels is used to provide a seat where the free end of an opposing handle portion can be releasably secured.

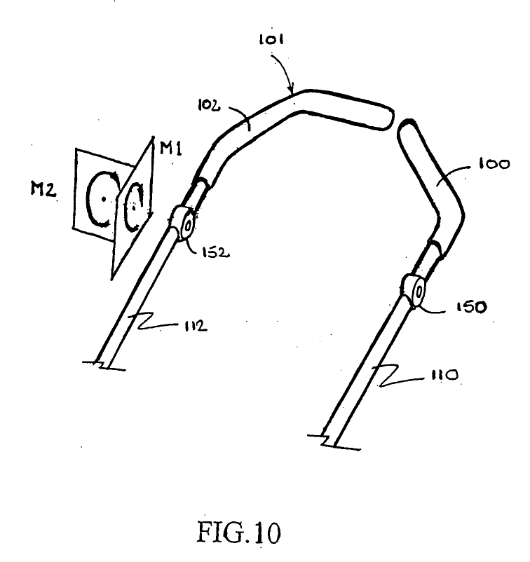

FIGS. 10-12—Additional Embodiments

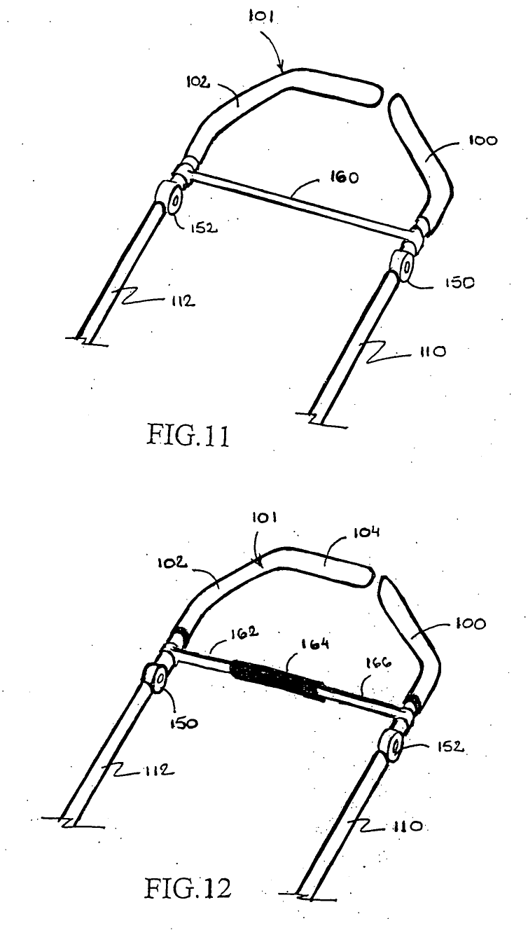

FIG. 10 shows a further embodiment of the handle arrangement where either the lower portions of the handles 100, 101 or the upper portions or the upwardly extending members 110, 112 are hinged at 150, 152 so that the tilt angle of the handles can be modified. The hinge axis of hinges 150, 152 is an axis that is perpendicular to the vertical longitudinal plane of the pushchair and generally parallel to the axis of the wheels of the pushchair, when these are in straight forward moving alignment. The tilt angle is useful to cater for users of different heights and for changing the leverage on the force that needs be exerted on the pushchair to lift the front wheels off the ground, as is normal in the case of transferring from the road to the pavement. When introducing the tilt angle in the independent handles of the invention and forces are applied to these handles in the course of normal use, two moment components will be produced at the tilting hinges, one moment M1 in a plane perpendicular to the hinge axis that produces the tilt, which is easily counterbalanced by the hinge locking mechanism and a second moment M2 in the plane of the hinge axis. This second moment produces great strain on the hinge and torsion along the length of the upwardly extending members 110, 112 that with use could lead to the feeling of fragility and lack of solidness of the pushchair structure. Furthermore, with the two handles being separate as in the case of this invention, adjusting the tilting angle of both handles independently might be in some cases an advantage as the angles and height of the handles would be further adjustable to the users choice, which may include asymmetrical adjustment. However it would also lead in many cases where tilt adjustment produces have slightly different tilt angles for both handles, and their symmetric adjustment could result annoying to the user, lead in many cases where tilt adjustment produces have slightly different tilt angles for both handles, and their symmetric adjustment could result annoying to the user. In order to cater for this last problem, FIG. 11 shows a torsion bar 154 that can be optionally fixed to both handles 100 and 101. The handle could be welded for a definitive solution, or preferably could be rigidly fixed via screws or damps in a way that would not allow for inelastic rotation of the torsion bar fixing point respect to the handles. In the case that the pushchair is designed to be collapsed in three dimensions, the torsion bar would need to be collapsible too along its length, i.e. the width dimension of the pushchair. In the case of a torsion bar as shown in the FIG. 12, the torsion bar can be collapsed via a non-rotating telescopic system, for example one having parts 162, 164 and 166 and provided with internal longitudinal grooves and matching protrusions. The “torsion bar” however can have many different configurations and may include a plurality of members linked in non-linear way, for example forming a curve or a U-shape. The structure and shape are not relevant as long as the torsion bar structure only allows “elastic” rotation of the opposing ends fixed to each of the handles, with respect to each other.

Conclusions Ramifications, and Scope

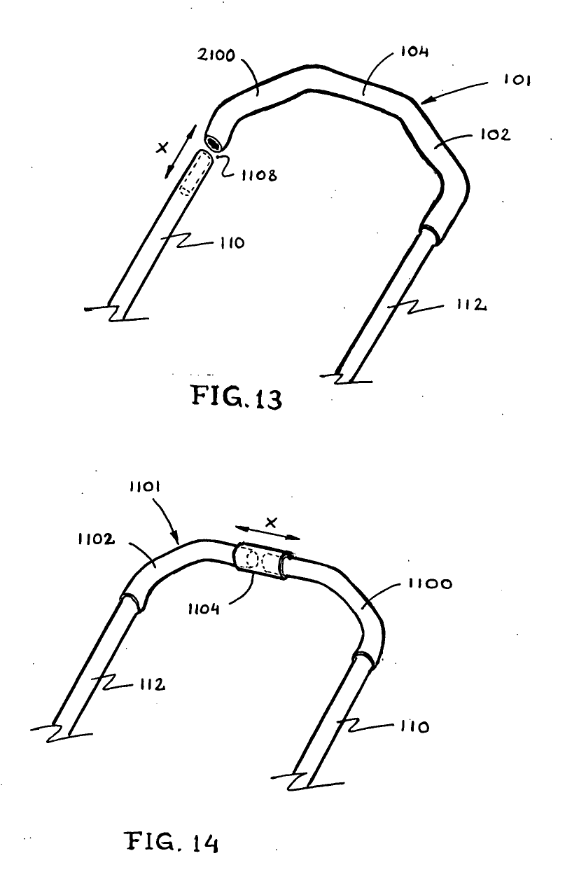

Many variations are possible to the described embodiments, for example as shown in FIG. 13 the said gap could be located between an upwardly extending member and one of the handles instead of between both handles, i.e. similar to the prior art dosed handle arrangement of FIG. 1B, but with an operating position having a gap at or near the end of the handle that is connected to the upwardly extending member. In this case, if the gap 1108 is created between the handle member 2100 and the upwardly extending member 110. If this gap is also releasably closable in a second operating condition, for example with similar mechanisms as those described in FIGS. 3A to 3C or 4A to 4B either in their sliding versions or their rotating threaded versions, then the material areas contacted by the mechanism effecting the releasable closure will also be considered as part of the “handle arrangement”. I.e. the part of the upwardly extending member on which the mechanism either is seated, articulated or is latched will also be considered as part of the “handle arrangement” for the purposes of this disclosure. Other variations may include a handle arrangement with an operating position having a gap located on the vertical plane passing through or near the centre of gravity of the pushchair and defining two handles or handle portions 1100, 1102 at each side, This arrangement could have a second operating position where a sleeve, rod or latch 1104 having also the form of a handle that can be moved or extended across the said gap so that the sleeve rod or latch, in the example the sleeve 1104 moving along direction X, would also extend across the vertical plane passing through the centre of gravity of the pushchair. This sleeve 1104 in the form of a handle could optionally have a mechanism similar to the one shown in FIGS. 3A to 3C or 4A to 4E either in their sliding versions or their rotating threaded versions. The embodiments described above are given by way of example only and various modifications may be apparent to the person skilled in the art without departing from the scope of the invention as defined by the appended claims.

1. A handle arrangement for a pushchair, the pushchair comprising first and second substantially upwardly extending members that are connectable to a handle arrangement at their upper portion for transmitting the motion producing force exerted by a user on the handle arrangement to the main body of the pushchair, the handle arrangement comprising a first handle member and a second handle member, said first handle member connectable to said first substantially upwardly extending member and said second handle member connectable to said second substantially upwardly extending member, characterised in that, in use, (a) said first and second handle members are connected to said first and second substantially upwardly extending members, respectively, (b) a portion of one of said first and second handle members extends through a plane selected from the group consisting of
i) a plane of symmetry of the pushchair,
ii) a vertical longitudinal plane containing the centre of gravity of the pushchair, to permit, when said portion is fully gripped, a momendess single handed pushing of the chair that produces substantially no horizontal turning moment about the centre of gravity of the pushchair and (c) under an operating condition a gap is allowed between the ends of said first and second handles that are opposite the ends that are connectable to said substantially upwardly extending members.

2. A handle arrangement for a pushchair, the pushchair comprising first and second substantially upwardly extending members that are connectable to a handle arrangement at their upper portion for transmitting the motion producing force exerted by a user on the handle arrangement to the main body of the pushchair, the handle arrangement comprising (a) a first connection end and a second connection end, for connecting to said first and second substantially upwardly extending members, respectively, (b) a first handle member extending from said first connection end, (c) a fully grippable portion of said first handle member extending, in use, through a plane selected from the group consisting of i) a plane of symmetry of the pushchair ii) a vertical longitudinal plane containing the centre of gravity of the pushchair, to permit, when said portion is fully gripped, a momentless single handed pushing of the chair that produces substantially no horizontal turning moment about the centre of gravity of the pushchair and (d) a second handle member extending between said fully grippable portion of said first handle member and said second connection end, (e) a portion of said second handle member extending from said second connection end, (e) an operating condition where a gap is defined by a free end of the said first handle member that is opposite the first connection end and free end of the said second handle portion that is opposite the said second connection end.

3. The handle arrangement of claim 1 where said gap is such as to allow the passage of the loop holding portion of a bag or container, so that a single handle member or a single upwardly extending member can be used as hook for the said loop holding portion.

4. The handle arrangement of claim 1 where the first handle member is longer that the second handle member, so that said gap is entirely located at one side with respect to the centre of symmetry or the vertical longitudinal plane containing the centre of gravity.

5. The handle arrangement of claim 1 where the first handle member, is linked so as to define two handle portions at either side of a link means.

6. The handle arrangement of claim 5 where one of said two handle portions extends, in use, either through the axis of symmetry or the vertical longitudinal plane containing the centre of gravity of the pushchair to permit a momentless single handed pushing of the chair that produces substantially no horizontal turning moment about the centre of gravity of the pushchair and is dimensioned to allow a full handgrip by the user.

7. The handle arrangement of claim 1 where the two handle portions, at either side of the link means, are angularly adjustable respect to one another.

8. The handle arrangement of claim 6 where the link means between the said two handle portions is selected from the group consisting of (a) a hinge (b) a universal joint.

9. The handle arrangement of claim 7 where the link means is adjustable between a condition permitting relative rotation and substantially rigid condition.

10. The handle arrangement of claim 5 where the link means between the said two handle portions comprises a releasably attachable connection.

11. The handle arrangement of claim 10 where the link means comprises also a retaining member that retains both said handle portions together and within a predefined distance of one another, when the said releasably attachable connection is disconnected.

12. The handle arrangement of claim 5 where the said two portions at either side of the linked part are both dimensioned to allow full handgrip by the user.

13. The handle arrangement of claim 1 having a second operating condition where the said gap can be temporarily closed by releasably connecting together the free ends of the first and the second handle members with a connecting means operated by the user, where the connecting means can be operated between connecting and non-connecting conditions.

14. The handle arrangement of claim 13, where the connecting means are hand operated so as to not require extra tools, and where the connecting means can be operated by the user using only one hand, between connecting and non-connecting conditions.

15. The handle arrangement of claims 13, where the connecting element comprises latching means.

16. The handle arrangement of claims 15, where said latching means moves through the said gap under a rotational movement, said rotational movement about an axis substantially perpendicular the axis defined by the imaginary line joining the free ends of the first and the second handle members.

17. The handle arrangement of claim 15, where said latching means comprises said portion of one of said first and second handle members.

18. The handle arrangement of claim 1, characterised in that (d) both said first and second handle members extend through the said plane to permit a momendess single handed pushing of the chair that produces substantially no horizontal turning moment about the centre of gravity of the pushchair and that (e) under an operating condition the gap is allowed between the end portions of said first and second handles that are opposite the ends that are connectable to said substantially upwardly extending members.

19. The handle arrangement of claim 18 where both the first and the second handle are each linked, so as to define each two handle portions at either side of a link means.

20. The handle arrangement of claim 19 where the two handle portions, at either side of the link means, are angularly adjustable respect to one another via the link means.

21. The handle arrangement of claim 19 where the link means between the said two handle portions comprises a releasably attachable connection.

22. The handle arrangement of claim 18 having a second operating condition where the said gap can be temporarily closed by releasably connecting together said first and the second handle members with a connecting means operated by the user.

23. The handle arrangement of claim 22, where the connecting means can be hand operated between attached and non-attached conditions so as to not require extra tools and where the connecting means can be operated between attached and non-attached conditions by the user using only one hand.

24. The handle arrangement of claims 22, where the connecting means comprises latching means.

25. The handle arrangement of claims 22, where the connecting means comprises attachment means.

26. The handle arrangement of claim 22, where said latching means moves through the said gap purely under a rotational movement.

27. The handle arrangement of claim 24, where said latching means comprises said portion of one of said first and second handle members.

28. The handle arrangement of claim 1 where the first and second handle members are constructed so that the can be connected to said upper portion of said the first and second substantially upwardly extending members that are connectable to a handle arrangement, where said upper portions have each a pre-fitted handle.

29. The handle arrangement of claim 28 where said first and second handle members are constructed to be releasably attachable to said pre-fitted handles.

30. The handle arrangement of claim 28 where said first and second handle members fit as an attachable sleeve over the said pre-fitted handles.

31. A handle arrangement for a pushchair according to claim 1 directly connected to the two upwardly extending members capable of transmitting force from the handle arrangement directly to the chassis of the pushchair.

32. The handle arrangement of claim 1 wherein the said handle arrangement is a pushchair handle.

33. The handle arrangement of claim 2 where said gap is such as to allow the passage of the loop holding portion of a bag or container, so that a single handle member or a single upwardly extending member can be used as hook for the said loop holding portion.

34. The handle arrangement of claim 33 having a second operating condition where the said gap can be temporarily closed by releasably connecting together the free ends of the first and the second handle members with a connecting means operated by the user, where the connecting means are hand operated so as to not require extra tools, and where the connecting means can be operated by the user using only one hand, between connecting and non-connecting conditions.

35. A handle arrangement for a pushchair, the pushchair comprising first and second substantially upwardly extending members, where at least said first member is connectable to the said handle arrangement at their upper portion for transmitting the motion producing force exerted by a user on the handle arrangement to the main body of the pushchair, the handle arrangement having an operating condition where:
a) it is connected to said first and second substantially upwardly extending members b) the handle arrangement comprising a free end that defines a gap in the handle arrangement, the gap allowing a closed loop member to be positioned solely with a member extending there through, the member selected from the group consisting of (i) the said first upwardly extending member (ii) the free end of the handle arrangement connected to said first upwardly extending member (iii) both (i) and (ii), and the gap allowing a section of said loop member to extend in between the first and second substantially upwardly extending members,
c) the handle arrangement having a first handle member, said first handle member connected to said first substantially upwardly extending member,
d) the handle arrangement characterised in that a handle portion of said first handle member extends through a vertical longitudinal plane passing through the centre of gravity of the pushchair to permit a user, fully gripping the said handle portion, momentless single handed pushing of the chair that produces substantially no horizontal turning moment about the said centre of gravity,
e) the handle arrangement also comprising a second handle portion extending between the said handle portion of said first handle member and said second substantially upwardly extending member.

36. The handle arrangement of claim 35 where said gap is such as to allow the passage of the loop holding portion of a bag or container, so that a single handle member or a single upwardly extending member can be used as hook for the said loop holding portion.

37. The handle arrangement of claim 36 having a second operating condition where the said gap can be temporarily closed by a releasable connecting means operated by the user, wherein the connecting means are hand operated so as to not require extra tools, and where the connecting means can be operated by the user using only one hand, between connecting and non-connecting conditions.

38. The handle arrangement of claim 1 where said first and second substantially upwardly extending members are hinged about an axis that is perpendicular to the vertical longitudinal plane of the pushchair and generally parallel to the axis of the wheels of the pushchair, whereby the tilt angle of the handles can be modified.
